(19) United States
(12) Patent Application Publication
(10) Pub. No.: US 2004/0120247 A1
(43) Pub. Date: Jun. 24, 2004

(54) Optical information storage medium and method of recording information on and/or reproducing information from the optical information storage medium

(75) Inventors: Kyung-geun Lee, Gyeonggi-do (KR); In-sik Park, Gyeonggi-do (KR); Myong-do Ro, Gyeonggi-do (KR); Chong-sam Chung, Gyeonggi-do (KR); Jae Seong Shim, Seoul (KR); Chang min Park, Gyeonggi-do (KR); Hyun-soo Park, Seoul (KR); Du-seop Yoon, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Suwon city (KR)

(21) Appl. No.: 10/654,617

(22) Filed: Sep. 4, 2003

(30) Foreign Application Priority Data
Sep. 6, 2002 (KR) 2002-53953
May 20, 2003 (KR) 2003-31907

(51) Int. Cl. G11B 7/24

(52) U.S. Cl. 369/275.3; 369/275.4

(57) ABSTRACT

An optical information storage medium includes a lead-in area, a user data area, and a lead-out area. Data is recorded as a pit wobble in all, or a portion of, the lead-in area and data is recorded as pits in the remaining area of the optical information storage medium. A method records data on, and/or reproduces data from, the optical information storage medium.

### CROSS-REFERENCE TO RELATED APPLICATIONS

This application claims the priority of Korean Patent Application No. 2002-53953, filed on Sep. 6, 2002 and 2003-31907, filed on May 20, 2003, in the Korean Intellectual Property Office, the disclosure of which is incorporated herein in its entirety by reference.

### BACKGROUND OF THE INVENTION

1. Field of the Invention

The present invention relates to an optical information storage medium and a method of recording information on, and/or reproducing information from, the optical information storage medium. More particularly, the present invention relates to an optical information storage medium in which data is recorded as a pit wobble in all or a portion of a lead-in area and as a pit in the remaining area of the optical information storage medium, and a method of recording information on and/or reproducing information from the optical information storage medium.

2. Description of the Related Art

Optical discs are generally used as information storage media of optical pickup devices which record information on and/or reproduce information from the optical discs without contacting the optical discs. Optical discs are classified as either compact discs (CDs) or digital versatile discs (DVDs) according to their information recording capacity. CDs and DVDs further include 650 MB CD-Rs, CD-RWs, 4.7 GB DVD+RWs, DVD-random access memories (DVD-RAMs), DVD-R/rewritables (DVD−RWs), and so forth. Read-only discs include 650 MB CDs, 4.7 GB DVD-ROMs, and the like. Furthermore, high density digital versatile discs (HD-DVD) having a recording capacity of 20 GB or more have been developed.

However, the above-mentioned optical information media are standardized according to their types to be compatibly used in reproducing devices. Thus, users may conveniently use the optical information media, and the cost for purchasing the optical information media may be saved. Attempts to standardize storage media that are not standardized have been made. In particular, the formats of new storage media have to be developed so that the new storage media are compatible with or consistent with existing storage media. Meanwhile, existing storage media use a method of recording data as pits or groove wobbles. Here, pits are miniature scratches that are physically formed in a substrate when manufacturing a disc, and groove wobbles are grooves that have a shape of a wave. Also, a pit signal is detected as a jitter value while a groove wobble signal is detected as a push-pull signal.

FIG. 1 is a graph of a push-pull signal and jitter with respect to the depth of a groove wobble or a pit. The depth of a groove wobble at which the push-pull signal is highest is about ⅛ (λ/n). The depth of a pit at which measured jitter is smallest is ¼ (λ/n). In an optical information storage medium having both groove wobbles and pits, it is preferable that the depth of the groove wobbles is different from the depth of the pits in consideration of the characteristics of the push-pull signal and jitter. However, in a case in which the depth of the groove wobbles is different from the depth of the pits, separate processes for forming the groove wobbles and the pits are required. Thus, a process of manufacturing the optical information storage medium is complicated. As a result, it is difficult to mass-produce the optical information storage media. Also, if the depth of the groove wobbles is identical to the depth of the pits to simplify the process of manufacturing the optical information storage medium, the characteristics of one or both of the push-pull signal and jitter deteriorate and recording/reproducing of data becomes less efficient.

### SUMMARY OF THE INVENTION

The present invention provides an optical information storage medium which may be manufactured by a simple process, produce effective signal characteristics, and be consistent with different types of optical storage media.

According to an aspect of the present invention, there is provided an optical information storage medium which includes a lead-in area, a user data area, and a lead-out area. Data is recorded as a pit wobble in all, or a portion of, the lead-in area and data is recorded as pits in the remaining area of the optical information storage medium.

The area in which data is recorded as a pit wobble may be an area in which information that is not modified on a storage medium complying with the same physical format is recorded.

The area in which data is recorded as a pit wobble may be an area in which optical information storage medium-related information is recorded.

A data recording modulation method used in the area in which data is recorded as a pit wobble may be different from a data recording modulation method used in the remaining area in which data is recorded as pits.

The data recording modulation method used in the area in which data is recorded as a pit wobble may be a bi-phase modulation method, and the data recording modulation method used in the remaining area in which data is recorded as pits may be an RLL modulation method.

A pattern of the pit wobble may match a pattern used in the user data area.

The pattern of the pit wobble may be a single pattern, a random pattern, or a combination of at least two or more patterns.

According to another aspect of the present invention, a method records information on, and/or reproduces information from, an optical information storage medium having a lead-in area, a user data area, and a lead-out area. Data is recorded as a pit wobble in all or a portion of the lead-in area. Data is recorded as pits in the remaining area of the optical information storage medium.

Additional aspects and advantages of the invention will be set forth in part in the description which follows and, in part, will be obvious from the description, or may be learned by practice of the invention.

### BRIEF DESCRIPTION OF THE DRAWINGS

The above features and/or advantages of the present invention will become more apparent by describing in detail exemplary embodiments thereof with reference to the attached drawings in which:

FIG. 1 is a graph illustrating variations in a push-pull signal and jitter based on the depth of groove wobbles or the depth of pits according to the related art;

FIG. 2 is a schematic view illustrating the physical structure of a recordable high density optical information storage medium;

FIG. 3 is a view illustrating a recording modulation method of a groove wobble;

FIG. 4 is a schematic view of the overall structure of an optical information storage medium according to an embodiment of the present invention;

FIG. 5 is a view illustrating a method of recording data on an optical information storage medium according to an embodiment of the present invention;

FIGS. 6A through 6C are views illustrating a pattern of a pit wobble in accordance with an embodiment of the present invention;

FIG. 7A is a view illustrating consecutive pit wobbles in accordance with an embodiment of the present invention; and

FIG. 7B is a view illustrating nonconsecutive pit wobbles in accordance with an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

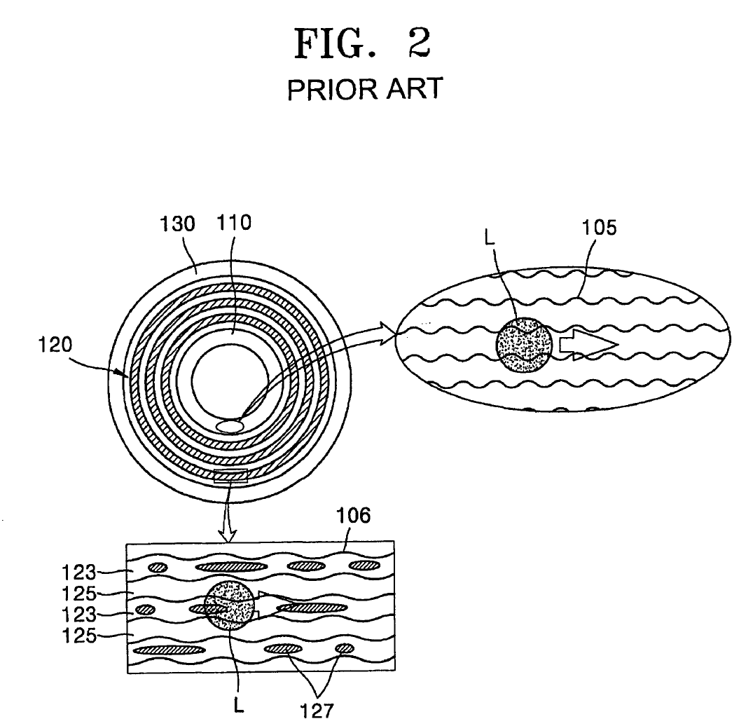

FIG. 2 is a schematic view illustrating the physical structure of a recordable high density optical information storage medium disclosed in Korean Patent No. 2001-23747 filed by the present applicant. The recordable high density optical information storage medium includes a lead-in area 110, a user data area 120, and a lead-out area 130, and has groove tracks 123 and land tracks 125. Here, user data may be recorded in the groove tracks 123 only or in both the groove tracks 123 and the land tracks 125.

When read only data is recorded in the lead-in area 110, wobble signals 105 and 106 having a specific frequency and waveform are sequentially recorded at the sidewalls of the groove tracks 123 and/or the land tracks 125, instead of pits. Here, a laser beam L is radiated onto a groove track 123 and/or a land track 125 to record data on or reproduce data from the groove track 123 and/or the land track 125. In particular, each of the lead-in area 110 and the lead-out area 130 includes a read only area in which disc-related information is recorded and a recordable area. The disc-related information is recorded in the form of a high frequency wobble 105 in the recordable areas of the lead-in area 110. The lead-out area 130, and the user data area 120 include frequency wobbles 106 relatively lower than the high frequency wobble 105. Reference numeral 127 denotes recording marks formed in the user data area 120.

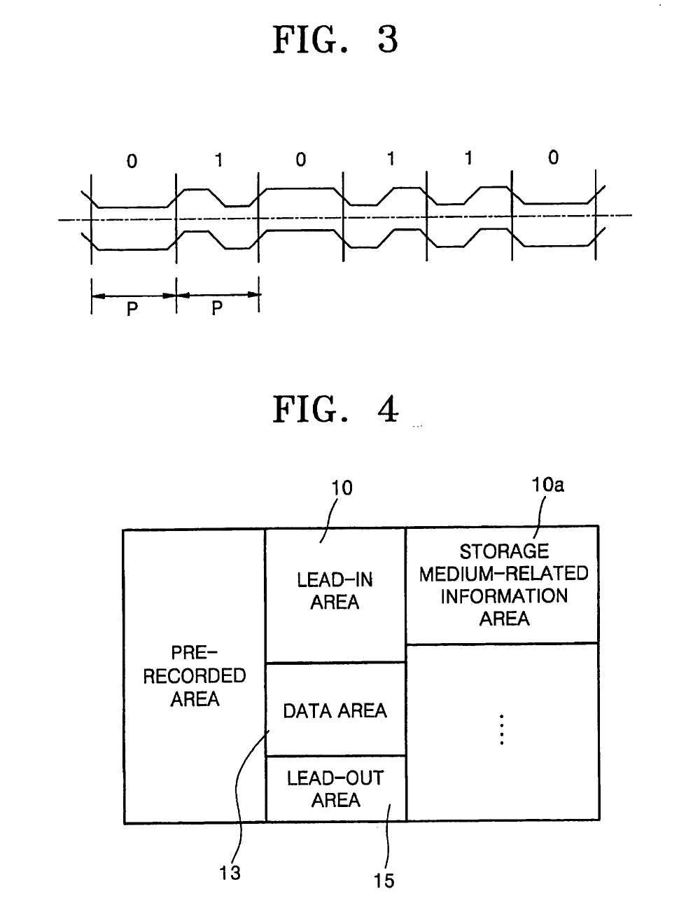

In the optical information storage medium having the above-described structure, read only data may be reproduced from the lead-in area 110 using a push-pull channel, and user data may be reproduced from the user data area 120 using a sum channel. Also, data recorded in the lead-in area 110 is modulated using a bi-phase modulation method, and user data is modulated using a Run Length Limit (RLL) modulation method that will be described later. The bi-phase modulation method refers to a method of modulating data depending on whether a signal varies within a predetermined period P. For example, as shown in FIG. 3, when the phase of a groove wobble does not change within a predetermined period P, data of 0 bits is displayed. When the phase of the groove wobble shifts within the predetermined period P, data of 1 bit is displayed. In other words, the bi-phase modulation method is a method of recording data depending on whether a predetermined signal varies within a predetermined period, e.g., depending on whether the phase of a signal changes within a predetermined period. Here, modulation of the phase of a groove wobble has been described, but various patterns may be modulated.

Considering the consistency of the recording modulation method of the above-described recordable high-density optical information storage medium with a recording modulation method of a read-only optical information storage medium according to an embodiment of the present invention, the physical data structure of the read-only optical information storage medium may be constituted as follows.

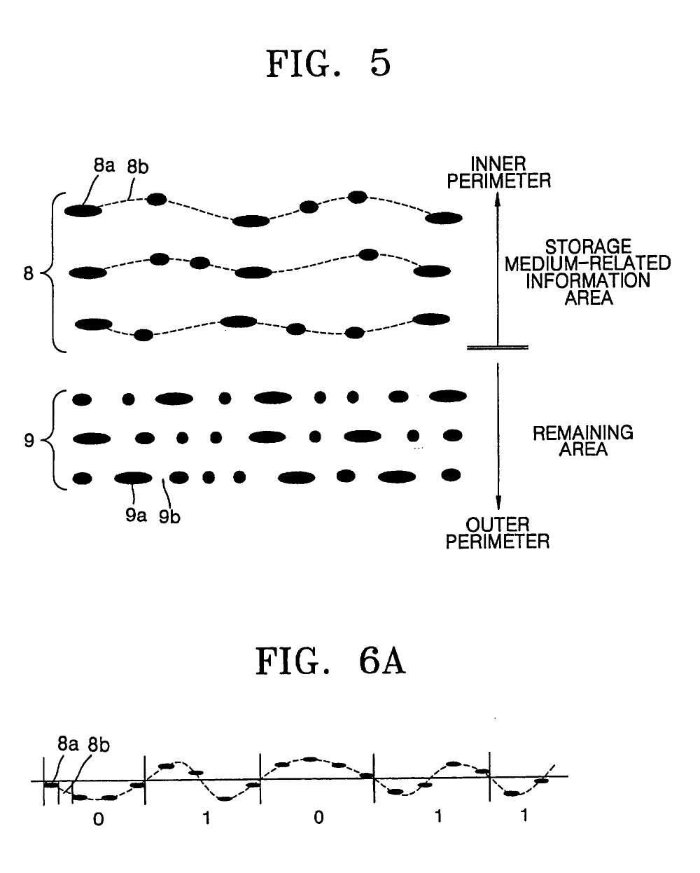

Referring to FIG. 4, an optical information storage medium according to an embodiment of the present invention includes a data area 13 in which user data is recorded, a lead-in area 10 which is formed inside the data area 13, and a lead-out area 15 which is formed outside the data area 13. In the lead-in area 10, the data area 13, and the lead-out area 15, data is recorded as pits. In particular, as shown in FIG. 5, in all, or a portion of, the lead-in area 10, data is recorded as a pit wobble 8. In the remaining area of the optical information storage medium, data is recorded as general pits 9. The pit wobble 8 is pits arranged in a waveform. The general pits 9 refer to pits that are arranged in a line. Hereinafter, the general pits 9 are referred to as simply “pits 9”.

The pit wobble 8 is formed in an area of the lead-in area 10 in which information (e.g., a modulation method, a minimum pit length, a track pitch, and the like) that is not modified on storage media complying with the same physical format is recorded. Here, examples of data that is not modified on the storage media complying with the same physical format are storage medium-related information or copy protection information. Storage medium-related information, for example, includes information on the type of the storage medium, such as a recordable disc, an only one-time recordable disc, a read only disc, information on the number of recording layers, information on a recording speed, information on the size of the disc, and the like. Information that varies depending on the contents of the storage medium, e.g., information such as the last address of a portion of a user data area in which data is recorded, is recorded as the pits 9.

The area in which data that is not modified on the storage media complying with the same physical format is recorded may be all, or a portion of, the lead-in area 10. For example, it is preferable that in a storage medium-related information area 10a of the lead-in area 10, where information that is not modified on the storage medium complying with the same physical format is recorded, data is recorded as the pit wobble 8, and in the remaining area of the optical information storage medium, data is recorded as the pits 9.

The pit wobble 8 may have the same period as the groove wobble of the previously described recordable high density information storage medium. Then, data may be reproduced using the same reproduction channel as the reproduction channel of the recordable high density information storage medium.

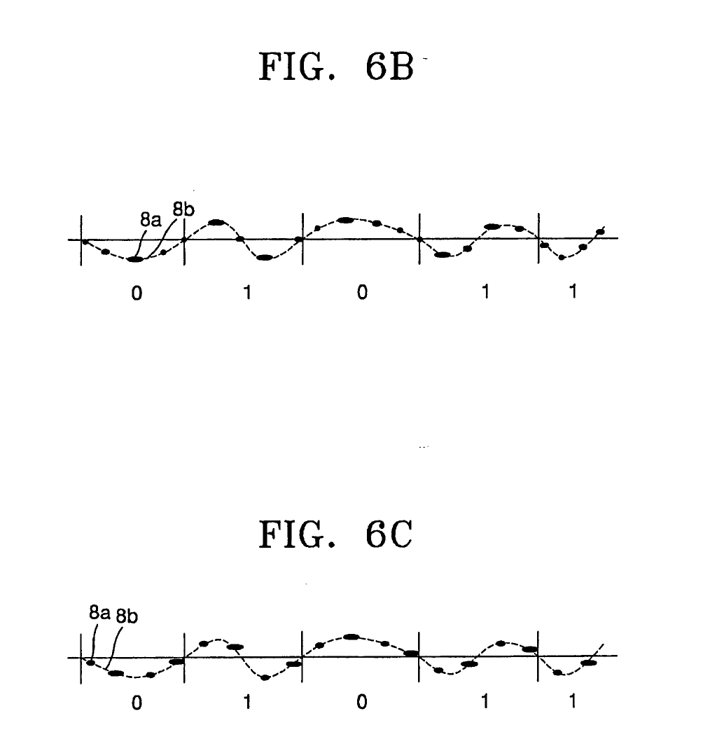

The pattern of the pit wobble 8 may be realized using various methods. For example, as shown in FIG. 6A, the pattern of the pit wobble 8 may be a single mark pattern formed of a mark 8a and a space 8b having the same length. In such a single mark pattern, a pit has no information, but information may be recorded in a wobble. Here, a push-pull channel may be used as a reproduction channel of a pit wobble. In a case in which information recorded in the lead-in area 10 is reproduced using a push-pull channel and information recorded in the user data area 13 is reproduced using a sum channel, the same reproduction channels as those of the previously described recordable high density information storage medium may be used, which is advantageous in terms of consistency.

The single mark pattern is useful in simplifying a process of manufacturing a recording medium. However, it is difficult to perform a tracking operation using the single mark pattern according to a differential phase detect (DPD) method used in a tracking servo. The DPD method is well known, and thus will not be described herein.

In consideration of this point, as shown in FIG. 6B, the pattern of the pit wobble 8 may be a random pattern. The random pattern refers to a pattern in which marks 8a having different lengths and spaces 8b having different lengths are randomly arranged and in which information may be recorded in pits and/or a wobble. If information is recorded in both the pits and the wobble, information may be reproduced from the pits and the wobble using a sum channel or a push-pull channel. Also, to increase a recording capacity, storage medium-related information may be recorded in the pits, and additional information may be recorded in the wobble, or storage medium-related information may be recorded in the wobble, and additional information may be recorded in the pits.

As shown in FIG. 6C, a pit wobble 8 may be formed with a pattern in which a sequence of marks having at least two different lengths and spaces having at two different lengths is repeated. For example, the pit wobble 8 may be formed with a pattern in which marks and spaces having a length of 2 T, and marks and spaces having a length of 5 T are repeatedly arranged. Here, T denotes a minimum mark length.

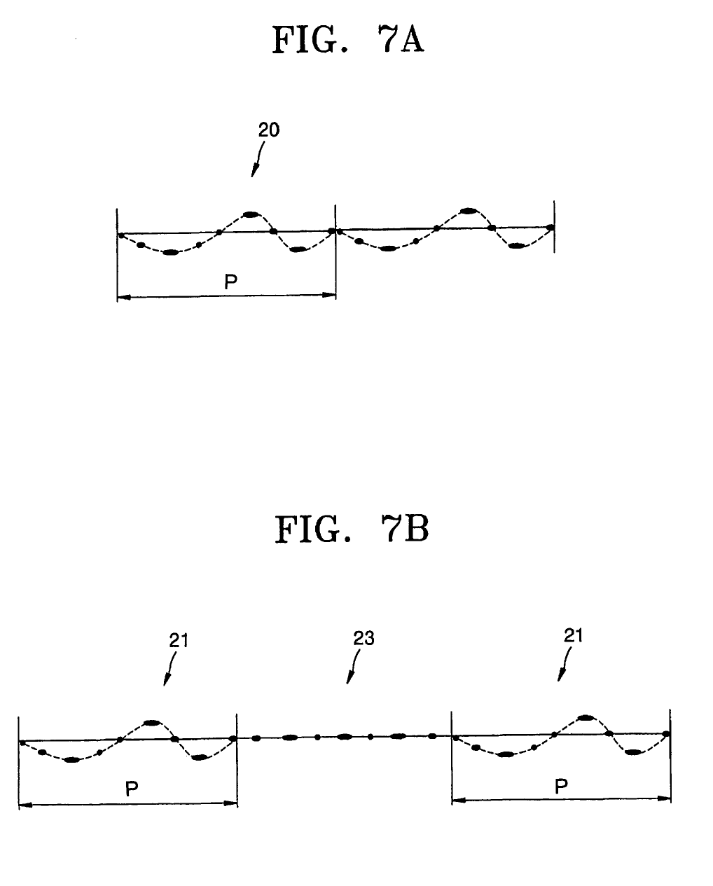

Information is generally recorded in the pits of the pit wobble 8. However, predetermined information may be recorded in the wobble of the pit wobble 8. The pit wobble 8 may be repeatedly recorded to improve reliability of such information. As shown in FIG. 7A, a pit wobble 20 is formed at least two consecutive times to record data. Here, the pit wobble 20 may have a period P and the same kind of information as well as being consecutively formed. When the first and the second pit wobbles are formed having different kinds of information, the first pit wobble may be recorded at least two consecutive times, and then the second pit wobble may be recorded at least two consecutive times. Accordingly, a plurality of pit wobbles including different kinds of information may be sequentially recorded at least two consecutive times.

As may be seen in FIG. 7B, a pit wobble 21 may be recorded at least two nonconsecutive times. Here, general pits 23 may be repeatedly formed between the nonconsecutive pit wobbles 21. In other words, when the first and the second pit wobbles are formed including different kinds of information, the first pit wobble and general pits may be formed, and then the second pit wobble and general pits may be formed. Accordingly, when a plurality of pit wobbles including different kinds of information are formed, general pits may be formed among the plurality of pit wobbles. Here, mirror areas may replace the general pits.

As described above, a pit wobble may be repeatedly recorded to smoothly reproduce all of information even when any one piece of the information is defective. As a result, the reliability of information may be improved.

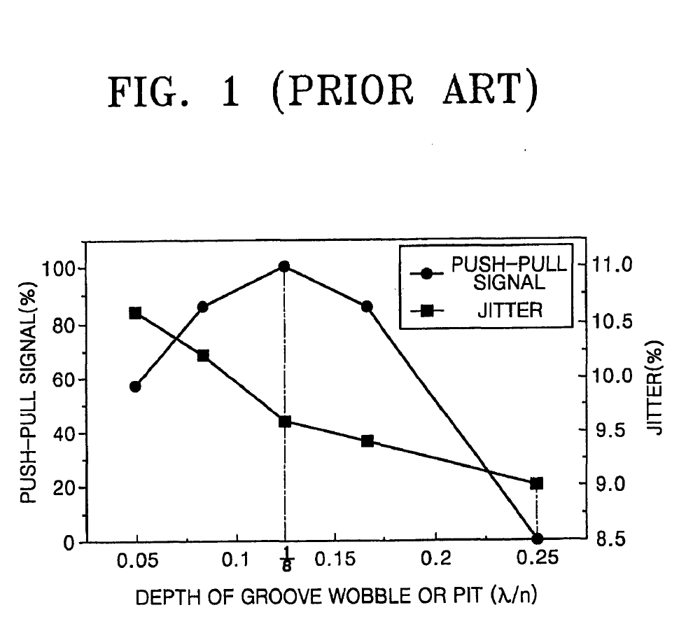

The pit wobble 8 or pits 9 are formed in a substrate in advance when manufacturing an optical information storage medium. If data is recorded as pits everywhere on an optical information storage medium, pits may be formed in the lead-in area 10 and the user data area 18 without stopping a process of forming the pits. Thus, a process of manufacturing an optical information storage medium may be simplified, and the time required to perform the process may be reduced. Also, since the optical information storage medium according to an embodiment of the present invention does not have a groove wobble, the pits may be formed to an optimal depth. In other words, as described with reference to FIG. 1, the pits may be formed to a depth at which jitter is lowest, e.g., a depth of ¼ (λ/A).

A data recording modulation method used in the entire lead-in area 10 or the portion of the lead-in area 10, i.e., the storage medium-related information area 10a, may be different from a data recording modulation method used in the remaining area of the information storage medium. For example, a bi-phase modulation method may be used throughout the entire lead-in area 10, or just in the storage medium-related information area 10a of the lead-in area 10, while a RLL modulation method is used in the remaining area of the information storage medium.

The RLL modulation method indicates how many bits of value “0” exist between two bits of value “1”. Here, RLL (d, k) represents that the minimum number and the maximum number of bits of value “0” between two bits of value “1” are d and k, respectively.

For example, data may be recorded in the storage medium-related information area 10a according to the bi-phase modulation method and in the remaining area of the lead-in area 10 according to a RLL (1, 7) modulation method.

As shown in FIGS. 6A through 6C, in the bi-phase modulation method, if the phase of a pit wobble does not shift within a predetermined period of time, data of bits of value “0” (or “1”) is recorded, and if the phase of the pit wobble shifts within a predetermine period of time, data of bits of value “1” (or “0”) is recorded.

In the RLL (1, 7) modulation method, the minimum number and the maximum number of bits of value “0” between two bits of value “1” are 1 and 7, respectively. According to the RLL (1, 7) modulation method, when d=1, data of 1010101 is recorded, and thus the length of a mark or a space between two bits of value “1” is 2 T. Also, when d=7, data of 10000000100000001 is recorded, and thus the length of a mark or a space between two bits of value “1” is 8 T. Thus, in the RLL (1, 7) modulation method, data is recorded as marks and spaces of length 2 T, and marks and spaces of length 8 T. Here, data recorded according to the bi-phase modulation method comprises a pit and a space having a length of nT, and a mark and a space having a length of 2 nT. The value of n may be within the range of 2≦n≦4. For example, if n=2, data recorded according to the bi-phase modulation method is comprised of pits and spaces having a length of 2 T, and pits and spaces having a length of 4 T. If n=4, data recorded according to the bi-phase modulation method is composed of pits and spaces having a length of 4 T, and marks and spaces having a length of 8 T. Thus, when n is within the range of 2≦n≦4, all data comprising pits and spaces having a length of nT, and pits and spaces having a length of 2 nT are included within the range of lengths of a mark and a space formed according to the RLL (1, 7) modulation method.

When a period of a mark and a space formed according to the bi-phase modulation method is included within the range of a period of a mark and a space formed in a user data area, read-only data pits in all, or a portion of, a lead-in area and data pits in the user data area 13 may be reproduced using the phase locked loop (PLL) circuit.

As another example, data may be recorded in all, or a portion of, the lead-in area 10, e.g., in the storage medium-related information area 10a, using the bi-phase modulation method and in the remaining area of the information storage medium using a RLL (2, 10) modulation method.

According to an RLL (2, 10) modulation method, data is recorded as marks 8a and spaces 8b with lengths in the range of 3 T-11 T. Here, data recorded according to the bi-phase modulation method may comprise marks 9a and spaces 9b having a length of nT, and marks 9a and spaces 9b having a length of 2 nT, and n may be within the range of 3≦n≦5. In other words, when n=3, data recorded according to the bi-phase modulation method may comprise marks and spaces having a length of 3 T, and marks and spaces having a length of 6 T. When n=5, data recorded according to the bi-phase modulation method includes pits and spaces having a length of 5 T, and pits and spaces having a length of 10 T. The lengths of the pits and the spaces recorded according to the bi-phase modulation method are within the range of 3 T-11 T, i.e., the range of the length of user data recorded according to the RLL (2, 10). Thus, as described previously, a data pit in a user data area and data in a lead-in area may be reproduced using the same PLL circuit.

The above-described method of recording data on and/or reproducing data from an optical information storage medium may be applied to a storage medium having one or more information layers.

As described above, according to an optical information storage medium and a method of recording information on and/or reproducing information from the optical information storage medium, pits are formed throughout the entire optical information storage medium. Thus, a process of manufacturing the optical information storage medium may be simplified. Also, the pits may be formed to a depth at which an optimum signal is output. Thus, recording/reproducing characteristics may be improved.

Also, the data recording modulation method used in all, or a portion of, the lead-in area and the data recording modulation method used in the remaining area of the optical information storage medium may coincide with a recording modulation method used on a recordable optical information storage medium. Thus, the read-only optical information storage medium may be consistent with other storage media. Moreover, a large amount of data may be recorded compared with when data is recorded as a groove wobble, and read-only data recorded in the lead-in area and user data may be reproduced using the same PLL circuit.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical information storage medium comprising:
a lead-in area;
a user data area; and
a lead-out area,
wherein data is recorded as a pit wobble in at least a portion of the lead-in area and data is recorded as pits in a remaining area of the optical information storage medium.

2. The optical information storage medium of claim 1, wherein the area in which the data is recorded as the pit wobble is an area in which unmodified information on a storage medium complying with a same physical format is recorded.

3. The optical information storage medium of claim 2, wherein the area in which the data is recorded as the pit wobble is an area in which optical information storage medium-related information is recorded.

4. The optical information storage medium of claim 3, wherein a first data recording modulation method used in the area in which the data is recorded as the pit wobble is different from a second data recording modulation method used in the remaining area in which the data is recorded as the pits.

5. The optical information storage medium of claim 4, wherein the first data recording modulation method used in the area in which the data is recorded as the pit wobble is a bi-phase modulation method, and the second data recording modulation method used in the remaining area in which the data is recorded as the pits is an RLL modulation method.

6. The optical information storage medium of claim 5, wherein the RLL modulation method is an RLL (1, 7) modulation method.

7. The optical information storage medium of claim 6, wherein information recorded according to the bi-phase modulation method comprises marks and spaces having a length of nT, and marks and spaces having a length of 2 nT, wherein n is within a range of 2≦n≦4 and T is a minimum mark length.

8. The optical information storage medium of claim 5, wherein the RLL modulation method is an RLL (2, 10) modulation method.

9. The optical information storage medium of claim 8, wherein information recorded according to the bi-phase modulation method comprises marks and spaces having a length of nT, and marks and spaces having a length of 2 nT, wherein n is within a range of 3≦n≦5 and T is a minimum mark length.

10. The optical information storage medium of claim 3, wherein a pattern of the pit wobble substantially matches a pattern used in the user data area.

11. The optical information storage medium of claim 10, wherein the pattern of the pit wobble is one of a single pattern, a random pattern, and a combination of at least two patterns.

12. The optical information storage medium of claim 3, wherein the pattern of the pit wobble is one of a single pattern, a random pattern, and a combination of at least two patterns.

13. The optical information storage medium of claim 3, wherein the data recorded as the pit wobble is reproduced using one of a push-pull channel and a sum channel.

14. The optical information storage medium of claim 1, wherein a first data recording modulation method used in the area in which the data is recorded as the pit wobble is different from a second data recording modulation method used in the remaining area in which the data is recorded as the pits.

15. The optical information storage medium of claim 14, wherein the first data recording modulation method used in the area in which the data is recorded as the pit wobble is a bi-phase modulation method, and the second data recording modulation method used in the remaining area in which the data is recorded as the pits is an RLL modulation method.

16. The optical information storage medium of claim 15, wherein the RLL modulation method is an RLL (1, 7) modulation method.

17. The optical information storage medium of claim 16, wherein information recorded according to the bi-phase modulation method comprises marks and spaces having a length of nT, and marks and spaces having a length of 2 nT, wherein n is within a range of 2≦n≦4 and T is a minimum mark length.

18. The optical information storage medium of claim 15, wherein the RLL modulation method is an RLL (2, 10) modulation method.

19. The optical information storage medium of claim 18, wherein information recorded according to the bi-phase modulation method comprises marks and spaces having a length of nT, and marks and spaces having a length of 2 nT, wherein n is within a range of 3≦n≦5 and T is a minimum mark length.

20. The optical information storage medium of claim 1, wherein a pattern of the pit wobble substantially matches a pattern used in the user data area.

21. The optical information storage medium of claim 20, wherein the pattern of the pit wobble is one of a single pattern, a random pattern, and a combination of at least two patterns.

22. The optical information storage medium of claim 1, wherein the pattern of the pit wobble is one of a single pattern, a random pattern, and a combination of at least two patterns.

23. The optical information storage medium of claim 1, wherein the data recorded as the pit wobble is reproduced using one of a push-pull channel and a sum channel.

24. The optical information storage medium of claim 1, wherein the optical information storage medium has at least one information surface.

25. The optical information storage medium of claim 1, wherein data recorded as the pit wobble is recorded at least two consecutive times.

26. The optical information storage medium of claim 1, wherein data recorded as the pit wobble is nonconsecutively recorded due to a pit row.

27. A method of recording information on and/or reproducing information from an optical information storage medium having a lead-in area, a user data area, and a lead-out area, the method comprising:
recording data as a pit wobble in at least a portion of the lead-in area; and
recording data as pits in a remaining area of the optical information storage medium.

28. The method of claim 27, wherein the area in which the data is recorded as the pit wobble is an area in which unmodified information on a storage medium complying with a substantially matching physical format is recorded.

29. The method of claim 28, wherein the area in which the data is recorded as the pit wobble is an area in which optical information storage medium-related information is recorded.

30. The method of claim 29, wherein a first data recording modulation method used in the area in which the data is recorded as the pit wobble is different from a second data recording modulation method used in the remaining area in which the data is recorded as the pits.

31. The method of claim 30, wherein the first data recording modulation method used in the area in which the data is recorded as the pit wobble is a bi-phase modulation method, and the second data recording modulation method used in the remaining area in which the data is recorded as the pits is an RLL modulation method.

32. The method of claim 31, wherein the RLL modulation method is an RLL (1, 7) modulation method.

33. The method of claim 32, wherein information recorded according to the bi-phase modulation method comprises marks and spaces having a length of nT, and marks and spaces having a length of 2 nT, wherein n is within a range of 2≦n≦4 and T is a minimum mark length.

34. The method of claim 31, wherein the RLL modulation method is an RLL (2, 10) modulation method.

35. The method of claim 34, wherein information recorded according to the bi-phase modulation method comprises marks and spaces having a length of nT, and marks and spaces having a length of 2 nT, wherein n is within a range of 3≦n≦5 and T is a minimum mark length.

36. The method of claim 29, wherein a pattern of the pit wobble substantially matches a pattern used in the user data area.

37. The method of claim 36, wherein the pattern of the pit wobble is one of a single pattern, a random pattern, and a combination of at least two patterns.

38. The method of claim 29, wherein the pattern of the pit wobble is one of a single pattern, a random pattern, and a combination of at least two patterns.

39. The method of claim 29, wherein data recorded as the pit wobble is reproduced using one of a push-pull channel and a sum channel.

40. The method of claim 27, wherein a first data recording modulation method used in the area in which data is recorded as a pit wobble is different from a second data recording modulation method used in the remaining area in which data is recorded as pits.

41. The method of claim 40, wherein the data recording modulation method used in the area in which data is recorded as a pit wobble is a bi-phase modulation method, and the data recording modulation method used in the remaining area in which data is recorded as pits is an RLL modulation method.

42. The method of claim 41, wherein the RLL modulation method is an RLL (1, 7) modulation method.

43. The method of claim 42, wherein information recorded according to the bi-phase modulation method comprises marks and spaces having a length of nT, and marks and spaces having a length of 2 nT, wherein n is within a range of 2≦n≦4 and T is a minimum mark length.

44. The method of claim 27, wherein the RLL modulation method is an RLL (2, 10) modulation method.

45. The method of claim 27, wherein data recorded as the pit wobble is recorded at least two consecutive times.

46. The method of claim 27, wherein data recorded as the pit wobble is nonconsecutively recorded due to a pit row.

47. The optical information storage medium of claim 1, wherein the optical information storage medium is one of a CD, a CD-R, a CD-RW, a DVD, a DVD+RW, a DVD-RAM, a DVD−RW, and a HD-DVD.

48. The optical information storage medium of claim 1, wherein the optical information storage medium is a read-only optical information storage medium.
